(19) United States
(12) Patent Application Publication
(10) Pub. No.: US 2025/0096848 A1
(43) Pub. Date: Mar. 20, 2025

(54) Devices and methods for coordinated sharing of transmission opportunities in a wireless network

(71) Applicant: HUAWEI TECHNOLOGIES CO., LTD., Shenzhen (CN)

(72) Inventors: Genadiy TSODIK, Hod Hasharon (IL); Arik KLEIN, Hod Hasharon (IL); Shimon SHILO, Hod Hasharon (IL); Oded REDLICH, Hod Hasharon (IL)

(21) Appl. No.: 18/965,064

(22) Filed: Dec. 2, 2024

Related U.S. Application Data
(63) Continuation of application No. PCT/EP2022/065246, filed on Jun. 3, 2022.

(51) Int. Cl. H04B 7/024; H04W 74/00; H04W 88/08

(52) U.S. Cl. CPC H04B 7/024; H04W 74/002; H04W 88/08

(57) ABSTRACT

A sharing access point, AP, is configured to share at least a portion of a transmission opportunity, TXOP, with one or more shared APs within a Multi-AP, M-AP, set for participating in a coordinated transmission. The sharing AP comprises a processing circuitry configured to generate a M-AP trigger frame; and a communication interface configured to transmit the M-AP trigger frame to a shared AP within the M-AP set. The M-AP trigger frame is configured to solicit the shared AP to initiate a coordination-related procedure with one or more non-AP stations associated with the shared AP and/or with one or more OBSS non-AP stations associated with one or more further shared APs within the M-AP set and to transmit a completion notification frame to the sharing AP. The communication interface is further configured to receive from the shared AP the completion notification frame indicating the completion of the coordination-related procedure.

### CROSS-REFERENCE TO RELATED APPLICATIONS

This application is a continuation of International Application No. PCT/EP2022/065246, filed on Jun. 3, 2022, the disclosure of which is hereby incorporated by reference in its entirety.

### TECHNICAL FIELD

The present disclosure relates to wireless communications. More specifically, the present disclosure relates to devices and methods for coordinated sharing of transmission opportunities in a wireless communication network.

### BACKGROUND

IEEE 802.11-based WLANs (also referred to as Wi-Fi networks) have become popular at an unprecedented rate. The 802.11 family of standards is constantly expanded by amendments and new generations of previous 802.11 standards to provide WLAN technology with new and improved technical features.

802.11be (also referred to as “Wi-Fi 7”) introduces a Multi AP (M-AP) coordinated transmission, where a group of access points (APs) may initiate concurrent frame exchange within a limited time period where one or more APs of the group of APs may share one or more transmission opportunities (TXOPs). The group of APs that have decided to cooperate and perform coordinated transmissions is called a M-AP set.

### SUMMARY

It is an objective to provide improved devices and methods for AP coordinated sharing of transmission opportunities in a wireless communication network, in particular an IEEE 802.11 based wireless communication network.

The foregoing and other objectives are achieved by the subject matter of the independent claims. Further implementation forms are apparent from the dependent claims, the description and the figures.

According to a first aspect a sharing access point, AP, is provided, wherein the sharing AP is configured to share at least a portion of a transmission opportunity, TXOP, with one or more shared APs within a Multi-AP, M-AP, set for participating in a coordinated transmission. The sharing AP comprises a processing circuitry configured to generate a M-AP trigger frame; and a communication interface configured to transmit the M-AP trigger frame to a shared AP within the M-AP set. The M-AP trigger frame is configured to solicit the shared AP to initiate a sequential, pre-transmission, coordination-related procedure with one or more BSS non-AP stations associated with the shared AP and/or with one or more OBSS non-AP stations associated with one or more further shared APs operating under the same coordination agreement within the same M-AP set and to transmit a completion notification frame to the sharing AP. The communication interface is further configured to receive from the shared AP the completion notification frame indicating the completion of the sequential, pre-transmission, coordination-related procedure by that shared AP.

In a further possible implementation form, the M-AP trigger frame comprises a M-AP set identifier indicative of the M-AP set.

In a further possible implementation form, the M-AP trigger frame comprises a coordination agreement identifier within the M-AP set. The coordination agreement identifier identifies one coordination agreement of a plurality of coordination agreements within the M-AP set and the sharing AP and the shared AP operate under the coordination agreement identified by the coordination agreement identifier within the M-AP set.

In a further possible implementation form, the M-AP trigger frame comprises an identifier of the shared AP.

In a further possible implementation form, the M-AP trigger frame comprises an indication indicative of a type of the sequential pre-transmission, coordination-related procedure.

In a further possible implementation form, the M-AP trigger frame comprises information about one or more parameters of the sequential pre-transmission, coordination-related procedure.

In a further possible implementation form, the M-AP trigger frame comprises an indication to the shared AP to initiate the transmission of the completion notification frame indicating the completion of the sequential pre-transmission, coordination-related procedure to the sharing AP.

In a further possible implementation form, the M-AP trigger frame comprises an indication indicative of a maximum time period for performing the sequential, pre-transmission, coordination-related procedure with the one or more non-AP stations associated with the shared AP and/or with the one or more OBSS non-AP stations associated with the one or more further shared APs operating under the same coordination agreement within the same M-AP set.

In a further possible implementation form, in case the communication interface has not received the frame indicating the completion of the sequential operation from the shared AP within the maximum time period indicated in the M-AP trigger frame, the communication interface is configured to transmit a further M-AP trigger frame to that shared AP within the M-AP set, wherein the further M-AP trigger frame is configured to solicit the shared AP to initiate the sequential, pre-transmission, coordination-related procedure with the one or more non-AP stations associated with the shared AP and/or with the one or more OBSS non-AP stations associated with the one or more further shared APs operating under the same coordination agreement within the same M-AP set.

In a further possible implementation form, the further M-AP trigger frame is further configured to solicit the shared AP to transmit a further completion notification frame indicating the completion of the sequential pre-transmission coordination-related procedure to that sharing AP.

In a further possible implementation form, in case the communication interface has not received the completion notification frame indicating the completion of the sequential, pre-transmission, coordination-related procedure from the shared AP within the maximum time period indicated in the M-AP trigger frame, the communication interface is configured to transmit a further M-AP trigger frame to a further shared AP operating under the same coordination agreement within the same M-AP set, wherein the further M-AP trigger frame is configured to solicit the further shared AP to initiate the sequential, pre-transmission, coordination-related procedure with one or more non-AP stations associated with the further shared AP and/or with the one or more OBSS non-AP stations associated with the one or more further shared APs operating under the same coordination agreement within the same M-AP set.

In a further possible implementation form, the further M-AP trigger frame is further configured to solicit the further shared AP to transmit to the sharing AP a further completion notification frame indicating the completion of the sequential, pre-transmission, coordination-related procedure by the further shared AP.

In a further possible implementation form, the completion notification frame indicating the completion of the sequential, pre-transmission, coordination-related procedure comprises a M-AP set identifier indicative of the M-AP set.

In a further possible implementation form, the completion notification frame indicating the completion of the sequential, pre-transmission, coordination-related procedure comprises a coordination agreement identifier within the M-AP set. The coordination agreement identifier identifies one coordination agreement of a plurality of coordination agreements within the M-AP set and the sharing AP and the shared AP operate under the coordination agreement identified by the coordination agreement identifier within the M-AP set.

In a further possible implementation form, the completion notification frame indicating the completion of the sequential, pre-transmission, coordination-related procedure comprises an indication indicative of a status of the sequential, pre-transmission, coordination-related procedure performed by the shared AP.

In a further possible implementation form, the completion notification frame indicating the completion of the sequential, pre-transmission, coordination-related procedure comprises an indication indicative of a request for an additional time period for performing the sequential, pre-transmission, coordination-related procedure by that shared AP.

In a further possible implementation form, the indication indicative of the request for an additional time period for performing the sequential, pre-transmission, coordination-related procedure by the shared AP comprises a value of the additional time period.

In a further possible implementation form, the completion notification frame indicating the completion of the sequential, pre-transmission, coordination-related procedure comprises information obtained by the shared AP during the performance of that sequential, pre-transmission, coordination-related procedure.

In a further possible implementation form, in response to receiving the completion notification frame indicating the completion of the sequential, pre-transmission, coordination-related procedure from the shared AP, the communication interface is configured to transmit a further M-AP trigger frame to that shared AP or a further shared AP operating under the same coordination agreement within the M-AP set. The further M-AP trigger frame solicits that shared AP or the further shared AP to initiate the sequential, pre-transmission, coordination-related procedure with the one or more non-AP stations associated with that shared AP, with one or more non-AP stations associated with the further shared AP and/or with one or more OBSS non-AP stations associated with one or more other further shared APs operating under the same coordination agreement within the same M-AP set.

In a further possible implementation form, the further M-AP trigger frame is further configured to solicit that shared AP or the further shared AP to transmit a further completion notification frame to the sharing AP indicating the completion of the sequential, pre-transmission, coordination-related procedure.

According to a second aspect a method of operating a sharing access point, AP, configured to share at least a portion of a transmission opportunity, TXOP, with one or more shared APs within a Multi-AP, M-AP, set for participating in a coordinated transmission is provided. The method comprises the steps of:
generating a M-AP trigger frame;
transmitting the M-AP trigger frame to a shared AP within the M-AP set, wherein the M-AP trigger frame is configured to solicit the shared AP to initiate a sequential, pre-transmission, coordination-related procedure with one or more BSS non-AP stations associated with the shared AP and/or with one or more OBSS non-AP stations associated with one or more further shared APs operating under the same coordination agreement within the same M-AP set and to further solicit the shared AP to transmit a completion notification frame to the sharing AP; and
receiving the completion notification frame from the shared AP indicating the completion of the sequential pre-transmission coordination-related procedure by the shared AP.

The method according to the second aspect of the present disclosure can be performed by the sharing AP according to the first aspect of the present disclosure. Thus, further features of the method according to the second aspect of the present disclosure result directly from the functionality of the sharing AP according to the first aspect of the present disclosure as well as its different implementation forms described above and below.

According to a third aspect a shared access point, AP is provided. The shared AP is configured to participate in a coordinated transmission making use of at least a portion of a transmission opportunity, TXOP, shared by a sharing AP within a Multi-AP, M-AP, set, wherein the shared AP comprises a communication interface configured to receive a M-AP trigger frame from the sharing AP within the M-AP set; and a processing circuitry configured to, in response to receiving the M-AP trigger frame, initiating a sequential, pre-transmission, coordination-related procedure with one or more non-AP stations associated with the shared AP and/or with one or more OBSS non-AP stations associated with one or more further shared APs operating under the same coordination agreement within the same M-AP set. The communication interface is further configured to transmit a completion notification frame to the sharing AP indicating the completion of the sequential, pre-transmission, coordination-related procedure by the shared AP.

In a further possible implementation form, the M-AP trigger frame comprises a M-AP set identifier indicative of the M-AP set.

In a further possible implementation form, the M-AP trigger frame comprises a coordination agreement identifier within the M-AP set. The coordination agreement identifier identifies one coordination agreement of a plurality of coordination agreements within the M-AP set and wherein the sharing AP and the shared AP operate under the coordination agreement identified by the coordination agreement identifier within the M-AP set.

In a further possible implementation form, the M-AP trigger frame comprises an indication indicative of a type of the sequential, pre-transmission, coordination-related procedure.

In a further possible implementation form, the M-AP trigger frame comprises an identifier of the shared AP.

In a further possible implementation form, the M-AP trigger frame comprises information about one or more parameters of the sequential, pre-transmission, coordination-related procedure.

In a further possible implementation form, the M-AP trigger frame comprises an indication to the shared AP to initiate the transmission of the completion notification frame indicating the completion of the sequential, pre-transmission, coordination-related procedure to the sharing AP.

In a further possible implementation form, the M-AP trigger frame comprises an indication indicative of a maximum time period for performing the sequential, pre-transmission, coordination-related procedure with the one or more non-AP stations associated with the shared AP and/or with the one or more OBSS non-AP stations associated with the one or more further shared APs operating under the same coordination agreement within the same M-AP set.

In a further possible implementation form, in case the sequential, pre-transmission, coordination-related procedure is not completed within the maximum time period indicated in the M-AP trigger frame, the completion indication frame comprises an indication indicative of a request for an additional time period for performing the sequential, pre-transmission, coordination-related procedure by the shared AP.

In a further possible implementation form, the indication indicative of the request for an additional time period for performing the sequential, pre-transmission, coordination-related procedure by the shared AP comprises a value of the additional time period.

In a further possible implementation form, the completion notification frame indicating the completion of the sequential, pre-transmission, coordination-related procedure comprises a M-AP set identifier indicative of the M-AP set.

In a further possible implementation form, the completion notification frame indicating the completion of the sequential, pre-transmission, coordination-related procedure comprises a coordination agreement identifier within the M-AP set. The coordination agreement identifier identifies one coordination agreement of a plurality of coordination agreements within the M-AP set and wherein the sharing AP and the shared AP operate under the coordination agreement identified by the coordination agreement identifier within the M-AP set.

In a further possible implementation form, the completion notification frame indicating the completion of the sequential pre-transmission coordination-related procedure comprises an indication indicative of a status of the sequential, pre-transmission, coordination procedure performed by the shared AP.

In a further possible implementation form, the completion notification frame indicating the completion of the sequential, pre-transmission, coordination-related procedure comprises information obtained by the shared AP during the performance of the sequential pre-transmission coordination-related procedure.

According to a fourth aspect method of operating a shared access point, AP, configured to participate in a coordinated transmission making use of at least a portion of a transmission opportunity, TXOP, shared by a sharing AP within a Multi-AP, M-AP, set is provided. The method comprises the steps of:
receiving a M-AP trigger frame from the sharing AP within the M-AP set;
initiating, in response to receiving the M-AP trigger frame, a sequential, pre-transmission, coordination-related procedure with one or more non-AP stations associated with that shared AP and/or with one or more OBSS non-AP stations associated with one or more further shared APs operating under the same coordination agreement within the same M-AP set; and
transmitting a completion notification frame to the sharing AP indicating the completion of the sequential pre-transmission coordination-related procedure by the shared AP.

The method according to the fourth aspect of the present disclosure can be performed by the shared AP according to the third aspect of the present disclosure. Thus, further features of the method according to the fourth aspect of the present disclosure result directly from the functionality of the shared AP according to the third aspect of the present disclosure as well as its different implementation forms described above and below.

According to a fifth aspect a computer program product is provided, comprising a computer-readable storage medium for storing program code which causes a computer or a processor to perform the method of according to the second aspect or the method according to the fourth aspect when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows an exemplary wireless communication network including a sharing AP and a shared AP for CoBF transmission according to an embodiment;

FIG. 2 shows a schematic diagram illustrating an exemplary CoBF scheme based on a sequential sounding procedure;

FIG. 3 shows a schematic diagram illustrating a general Sequential Pre-TX Coordination-related Procedure performed by a sharing AP according to an embodiment and a shared AP according to an embodiment;

FIG. 4 shows a schematic diagram illustrating a Sequential Pre-TX Coordination Procedure with time limitation rules performed by a sharing AP according to an embodiment and a shared AP according to an embodiment;

FIG. 5 is a flow diagram illustrating a method of operating a sharing AP according to an embodiment; and

FIG. 6 is a flow diagram illustrating a method of operating a shared AP according to an embodiment.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Coordinated BF (CoBF) is a coordination scheme proposed for the next generation Wi-Fi for simultaneous coordinated data transmission by several APs. This coordination scheme assumes that each participating AP has the capability to precode its transmitted signal such that mutual interference between this AP and the STAs of the OBSS (Overlapping BSS) during coordinated transmission is minimized (also referred to as nulling). Similarly, to all other coordination schemes, CoBF is initialized by a sharing AP that proposes other APs (referred to as shared APs) to transmit simultaneously. The proposed resources in this case are spatial streams, where the sharing AP assigns a specific respective number of spatial streams to each shared AP. CoBF may make use of an additional preceding sequential sounding procedure for estimating the channels between the APs and STAs, which, however, is not addressed in further detail herein. Based on the estimated channel parameters, the APs may construct precoder matrices for generating beams towards the no-AP STAs from the same BSS that are involved in the coordinated transmission and nulls toward STAs from the OBSS that are involved in the current CoBF transmissions.

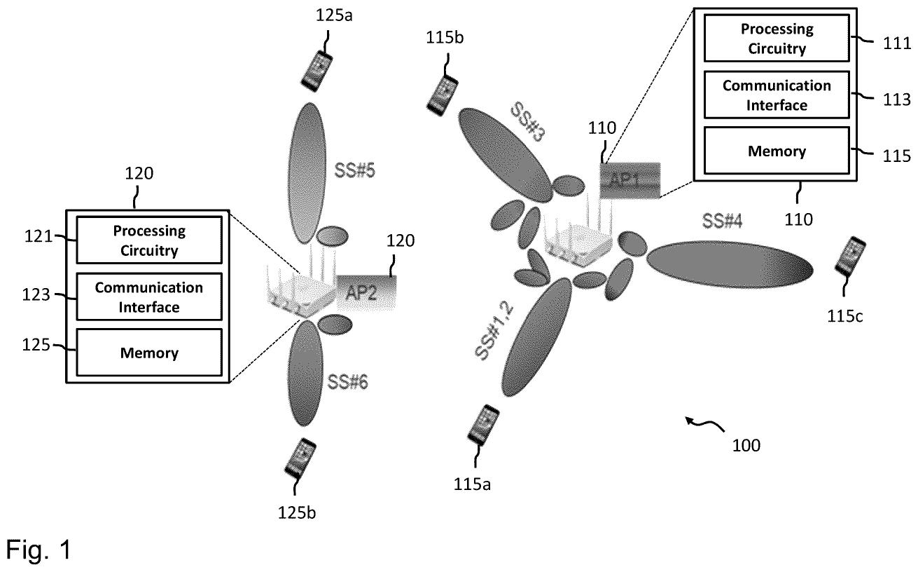

FIG. 1 shows an exemplary wireless communication network 100 including a sharing AP 110 and a shared AP 120 for CoBF transmission according to an embodiment. The sharing AP 110 is configured to share at least a portion of a transmission opportunity, TXOP, with the shared AP 120 operating under the same coordination agreement within a Multi-AP set (also referred to as M-AP set) for participating in a coordinated beamforming (CoBF) transmission. In the exemplary embodiment shown in FIG. 1, the sharing AP 110 is configured to communicate with its associated stations 115a, 115b and 115c, while the shared AP 120 is configured to communicate with its associated stations 125a, 125b.

As illustrated in FIG. 1, the sharing AP 110 comprises a processing circuitry 111 and a communication interface 113, in particular a wireless communication interface 113 in accordance with the IEEE 802.11 framework of standards. The processing circuitry 111 may be implemented in hardware and/or software and may comprise digital circuitry, or both analog and digital circuitry. Digital circuitry may comprise components such as application-specific integrated circuits (ASICs), field-programmable arrays (FPGAs), digital signal processors (DSPs), or general-purpose processors. The sharing AP 110 may further comprise a memory 115 configured to store executable program code which, when executed by the processing circuitry 111, causes the sharing AP 110 to perform the functions and methods described herein.

Likewise, the shared AP 120 illustrated in FIG. 1 comprises a processing circuitry 121 and a communication interface 123, in particular a wireless communication interface 123 in accordance with the IEEE 802.11 framework of standards. The processing circuitry 121 may be implemented in hardware and/or software and may comprise digital circuitry, or both analog and digital circuitry. Digital circuitry may comprise components such as application-specific integrated circuits (ASICs), field-programmable arrays (FPGAs), digital signal processors (DSPs), or general-purpose processors. The shared AP 120 may further comprise a memory 125 configured to store executable program code which, when executed by the processing circuitry 121, causes the shared AP 120 to perform the functions and methods described herein.

Before describing different embodiments of the sharing AP 110 and the shared AP 120 in more detail, in the following some technical background as well as terminology concerning wireless devices in accordance with the IEEE 802.11 WLAN framework of standards will be introduced making use of one or more of the following abbreviations:
AP Access Point
BFR Beamforming Report
BFRP Beamforming Report Poll trigger frame
BSS Basic Serving Set
COBF Coordinated Beamforming
NDP Null Data PPDU
NDPA NDP Announcement
M-AP Multi-AP
OBSS Overlapping BSS
SCI shared AP Complete Indication
STA Station (in general, can be either an AP STA or a non-AP STA)
TF Trigger Frame
TXOP Transmission opportunity

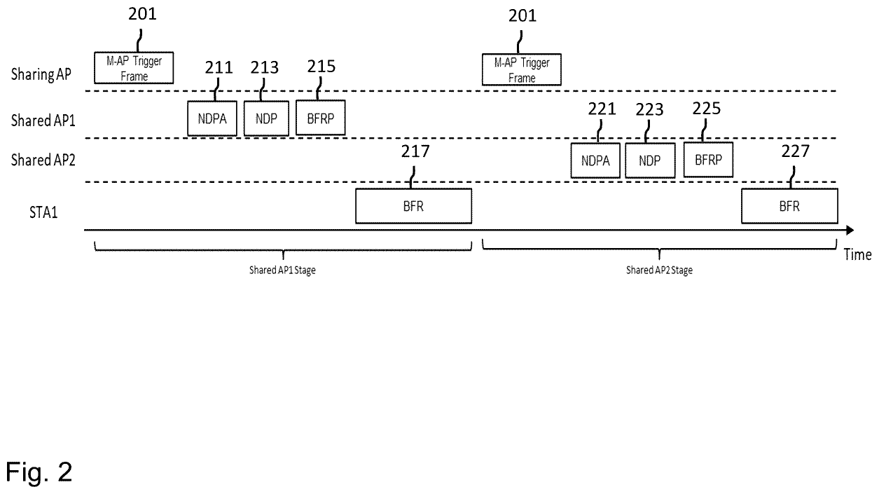

FIG. 2 shows a schematic diagram illustrating a CoBF scheme based on a sequential sounding procedure. 802.11be introduces a Multi AP (M-AP) coordinated transmission operations, where multiple access points (APs) share resources in order to allow parallel transmissions in several BSSs and more efficient utilization of their resources. Some coordinated schemes involve Pre-TX sequential procedures that should be performed prior to coordinated data transmission. The purpose of those procedures is to collect some parameters or manage the network.

For example, the CoBF scheme illustrated in FIG. 2 requires a sequential sounding procedure where shared APs obtain a sounding feedback parameters, i.e. collected through a beamforming report (BFR) frame 217, 227 from BSS and/or OBSS STAs. These may be triggered by the respective shared AP by sending a beamforming report poll trigger (BFRP) frame 215, 225, which follow a Null Data Packet Announcement (NDPA) frame 211, 221 to notify the involved STAs that need measure the channel parameters using the Null Data PPDU (NDP) 213, 223.

These procedures may consist of several stages where at each stage a single shared AP is triggered by the sharing AP using a regular M-AP Trigger Frame 201 to perform its operation.

The completion of the entire procedure may be achieved only when each stage is successfully completed. Thus, the shared AP should indicate to the sharing AP the completion of the current stage and also may provide some information depending on the coordination scheme. If a stage was not completed, the shared AP should indicate this and/or ask for more resources to finish all the required actions. Moreover, at each stage sharing AP should be the only manager of the resources. This means that first sharing AP should define the maximum time period allocated to current stage. In addition, in order to prevent deadlocks, the sharing AP should get back the control on the resources at the end of this time period. As will be appreciated, at least some of those requirements described above are crucial for successful and efficient coordinated Pre-TX sequential procedures.

Embodiments disclosed herein provide new frames that can support a sequential Pre-TX procedures with the following properties: (i) each stage of the sequential procedures will be fully controlled by the sharing AP; (ii) the shared AP may indicate the completion of its stage or ask for more resources to complete its stage; and (iii) each stage may be time limited, while the sharing AP (as the TXOP Holder) automatically gets back the control on the resources at the end of the allocated time period for the sequential procedure. Such a solution will be described in more detail in the embodiments below.

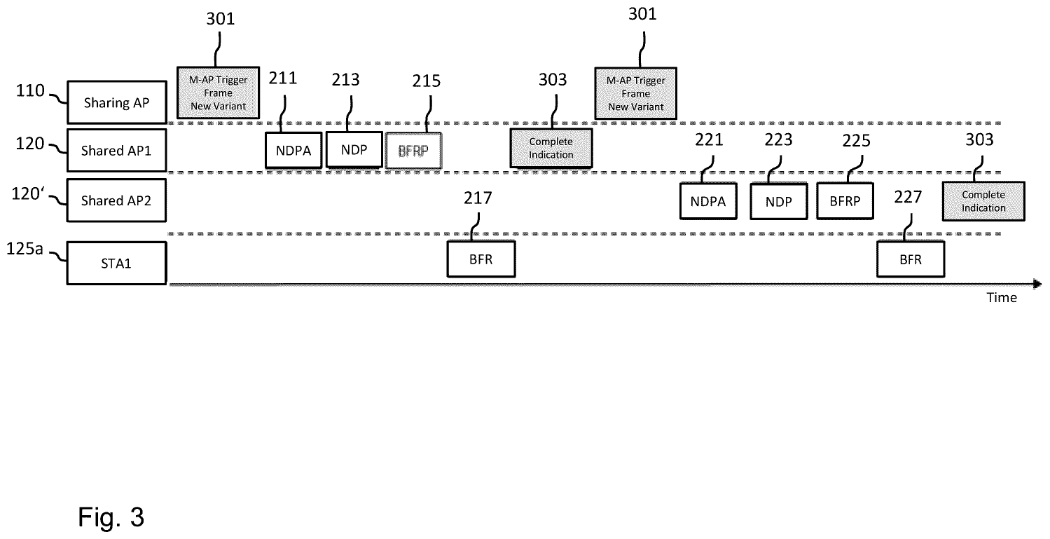

FIG. 3 shows a schematic diagram illustrating a general Pre-TX Sequential Coordination-related Procedure performed by the sharing AP 110 according to an embodiment and the shared AP 120 according to an embodiment. The main idea is a design of two frames 301, 303 that allow to manage the Pre-TX sequential coordination-related procedures.

As will be described in more detail below, the sharing access point, AP, 110 shown in FIG. 1 and FIG. 3 is configured to share at least a portion of a transmission opportunity, TXOP, with one or more shared APs 120 within a Multi-AP, M-AP, set for participating in a coordinated transmission. The processing circuitry 111 of the sharing AP 110 is configured to generate a M-AP trigger frame 301 and the communication interface 113 of the sharing AP 110 is configured to transmit the M-AP trigger frame 301 to the shared AP 120 within the M-AP set, wherein the M-AP trigger frame 301 is configured to solicit the shared AP 120 to initiate a coordination-related procedure with one or more non-AP stations 125a, associated with the shared AP 120 and/or with one or more OBSS non-AP stations associated with one or more further shared APs 120′ within the M-AP set and to transmit a completion notification frame 303 to the sharing AP 110. The communication interface 113 is further configured to receive from the shared AP 120 and the shared AP 120′ the completion notification frame(s) 303 indicating the completion of the coordination-related procedure.

Thus, in the embodiment shown in FIG. 3, the sharing AP 110 is operating under a coordination agreement with the shared AP1 120 and the further shared AP2 120′ for a coordination scheme of Co-Beam forming. The non-AP station STA1 125a is associated with the shared AP1 120. Thus, it is considered as a BSS station of the shared AP1 120 and an OBSS station of the further shared AP2 120′. In order to apply a coordinated transmission of both shared AP1 120 and shared AP2 120′ (along with the sharing AP 110), each of the shared APs 120, 120′ is required to collect the channel parameters with the non-AP station STA1 125a. Consequently, the sharing AP 110 may allocate a sequential sounding procedure for the shared AP1 120 to collect the channel parameters with the non-AP station STA1 125a (in order to direct the beam with the relevant data for that non-AP station) and further allocate a sequential sounding procedure for the shared AP2 120′ to collect the channel parameters with the non-AP station STA1 125a (in order to generate a null towards the non-AP station STA1 125a, when it transmits data to its own BSS non-AP stations).

Complementary to the sharing AP 110, the shared access point, AP, 120 shown in FIG. 1 and FIG. 3 is configured to participate in the coordinated transmission making use of at least a portion of a transmission opportunity, TXOP, shared by the sharing AP 110 within the Multi-AP, M-AP, set. The communication interface 123 of the shared AP 120 is configured to receive the M-AP trigger frame 301 from the sharing AP 110 within the M-AP set and the processing circuitry 121 of the shared AP 120 is configured to, in response to receiving the M-AP trigger frame 301, initiating a sequential pre-TX, coordination-related procedure with one or more non-AP stations associated with the shared AP 120 and/or with one or more OBSS non-AP stations associated with one or more further shared APs 120′ within the M-AP set. The communication interface 123 of the shared AP 120 is further configured to transmit the completion notification frame 303 to the sharing AP 110 indicating the completion of the coordination-related procedure.

Thus, the completion notification frame 303 (which may also be referred to as Shared AP Complete Indication frame 303 or short SCI frame 303) is transmitted as completion indication to the sharing AP 110 which precedingly transmitted the new variant of M-AP trigger frame 301. The M-AP trigger frame 301 may be used to trigger a single shared AP 120, 120′ at a time to perform its stage of Pre-TX sequential coordination-related procedure. As described in more detail below, the completion notification frame 303 may indicate that the triggered stage of Pre-TX procedure is completed, provide a scheme dependent information to the sharing AP 110 or request more time to complete the Pre-TX procedure (if needed).

As will be appreciated, the assignment of roles of the STAs to the sharing AP 110 and the shared AP 120, 120′ may change once the sharing of the portion of the transmission opportunity is complete.

The M-AP trigger frame 301 may comprise information, i.e. an indication about one or more parameters of the coordination-related procedure. An indication of the new M-AP trigger frame TF 301 variant may comprise a currently reserved option of TF type field or a special indication.

The M-AP trigger frame 301 may comprise an identifier of the shared APs 120, 120′ within the M-AP set. Thus, by such an indication of a single triggered shared AP 120, 120′ only a single shared AP 120, 120′ may be triggered by the M-AP trigger frame 301.

The M-AP trigger frame 301 may comprise an indication indicative of a type of the coordination procedure. The indication may be a sequential procedure type indication, for example NDP sounding, collecting power headroom values which indicates a procedure type triggered by current M-AP TF 301.

The M-AP trigger frame 301 may comprise an indication indicative of a time period for performing the coordination-related procedure with the one or more non-AP stations associated with the shared AP 120 and/or with the one or more OBSS non-AP stations associated with the one or more further shared APs 120′ within the M-AP set. Thus, a duration allocated for a specific stage which may be a time period allocated for a current stage of the sequential Pre-TX coordination-related procedure is provided. Rules related to this indication will be described below.

The M-AP trigger frame 301 may comprise a coordination agreement identifier within the M-AP set, wherein the coordination agreement identifier identifies one coordination agreement of a plurality of coordination agreements within the M-AP set and wherein the sharing AP 110 and the shared AP 120 operate under the coordination agreement identified by the coordination agreement identifier within the M-AP set. Moreover, the M-AP trigger frame 301 may comprise a M-AP set identifier indicative of the M-AP set.

Thus, coordination scheme dependent info which may be a new field in the M-AP TF 301 that may comprises information and/or parameters relevant for a specific sequential procedure triggered by the M-AP TF 301. Subfields of this field may be different for different coordination schemes and sequential procedures.

The M-AP trigger frame 301 may comprise an indication to the shared AP 120 to initiate the transmission of the completion notification frame 303 indicating the completion of the Pre-TX coordination-related procedure towards the sharing AP 110.

The completion notification frame 303 may be required to be transmitted by the shared AP 120, 120′ within the time period allocated for the current stage of sequential Pre-TX coordination-related procedure, for example as defined in the M-AP trigger frame 301. The completion notification frame, 303 may comprise the indication and parameters described in more detail below.

The completion notification frame 303 may comprise a M-AP set identifier, i.e. a M-AP Set ID indicative of the M-AP set.

The completion notification frame 303 may comprise a coordination agreement identifier, i.e. a Coordination Agreement ID within the M-AP set, wherein the coordination agreement identifier identifies one coordination agreement of a plurality of coordination agreements within the M-AP set and wherein the sharing AP 110 and the shared AP 120 operate under the coordination agreement identified by the coordination agreement identifier within the M-AP set.

The completion notification frame 303 may comprise an indication indicative of a status of the Pre-TX coordination-related procedure performed by the shared AP 120. The status may indicate a completion, no completion or an abort of a stage. As will be appreciated, the status indication is only an information provide to the sharing AP 110, but no action is decided by the shared AP 120, 120′.

The completion notification frame 303 may comprise an indication indicative of a request for an additional time period for performing the sequential pre-TX coordination-related procedure by the shared AP 120. The indication indicative of a request for an additional time period may be linked to the indication indicative of a status of the coordination-related procedure indicating no completion of a stage. The indication indicative of the request for an additional time period for performing the sequential pre-TX coordination-related procedure by the shared AP 120 may comprise a value of the additional time period. Thus, additional time may be requested by the shared AP 120 with specification of the time period in units of time.

The completion notification frame 303 may comprise information obtained by the shared AP 120 during the performance of the sequential pre-TX coordination-related procedure. The information may be a coordination scheme dependent information in which in some coordination scheme/procedures the shared AP 120 may include information obtained during the sequential procedure. The subfield of this field may include different content for different coordination schemes and sequential procedures. For example, the completion notification frame 303 may contain information corresponding to that received in the BFRs 217, 227.

Upon receiving the M-AP TF 301, the shared AP 120 may execute the required steps of the corresponding sequential procedure. Moreover, the shared AP 120 may indicate at the end of stage the stage status using the completion notification frame 303.

Complementary, upon sending the M-AP TF 301, the sharing AP 110 may wait for the completion notification frame 303 indicating the end of triggered stage. Moreover, the sharing AP 110 may apply a time counter till the time counter reaches the timeout as defined by a request for additional time by the shared AP 120 or as defined in the M-AP TF 301. Upon receiving the completion notification frame 303, the sharing AP 110 may, if completion is indicated, trigger the next stage or finish the procedure if the completion notification frame 303 is received from the shared AP 120′ 120′ that is the last shared AP 120, 120′ or if something unexpected has happened. Moreover, if more time is requested, the sharing AP 110 may be configured to trigger the same stage of the sequential Pre-TX coordination-related procedure with the same shared AP 120,120′ with a new allocated time period.

In response to receiving the completion notification frame 303 from the shared AP 120, the communication interface 113 of the sharing AP 110 may be configured to transmit a further M-AP trigger frame 301 to the shared AP 120 or a further shared AP 120′ within the M-AP set, wherein the further M-AP trigger frame 301 solicits the shared AP 120 or the further shared AP 120′ to initiate the Sequential Pre-TX coordination-related procedure with the one or more non-AP stations associated with that shared AP, with one or more non-AP stations associated with the further shared AP 120′ and/or with one or more OBSS non-AP stations associated with one or more other further shared APs 120′ operating under the same coordination agreement within the same M-AP set.

The further M-AP trigger frame 301 may be further configured to solicit the shared AP 120 or the further shared AP 120′ to transmit a further completion notification frame 303 to the sharing AP 110 indicating the completion of the Sequential Pre-TX coordination-related procedure.

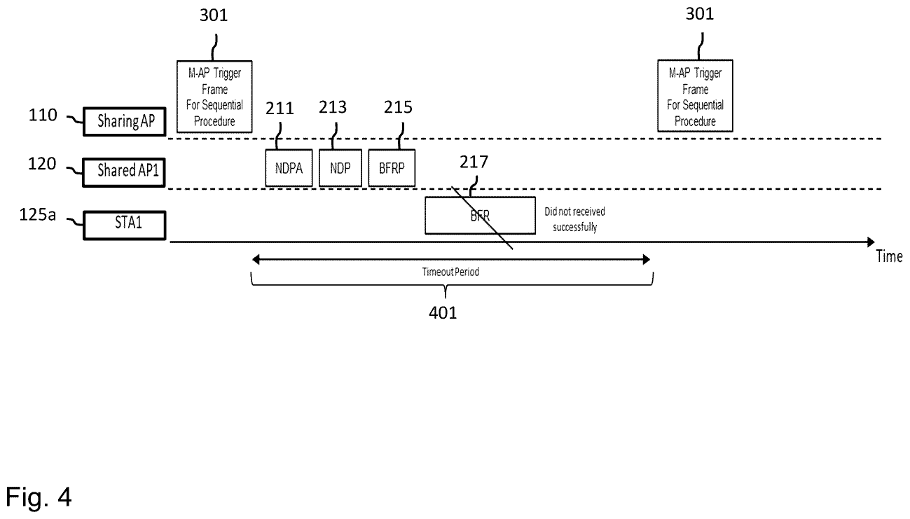

FIG. 4 shows a schematic diagram illustrating a Sequential Pre-TX Coordination-related Procedure with time limitation rules performed by the sharing AP 110 according to an embodiment and the shared AP 120 according to an embodiment.

In case the communication interface 113 of the sharing AP 110 has not received the frame indicating the completion of the sequential operation from the shared AP 120 within the time period 401 indicated in the M-AP trigger frame 301, the communication interface 113 of the sharing AP 110 may be configured to transmit a further M-AP trigger frame 301 to the shared AP 120 within the M-AP set. The further M-AP trigger frame 301 may be configured to solicit the shared AP 120 to initiate the Sequential Pre-TX coordination-related procedure with the one or more non-AP stations associated with that shared AP 120 and/or with the one or more OBSS non-AP stations associated with the one or more further shared APs 120 operating under the same coordination agreement within the M-AP set.

If the time period 401 allocated for a current sequential Pre-TX coordination-related stage has ended, no frames may be further transmitted by any of the shared APs 120, 120′. The shared APs 120, 120′ may then wait for the next M-AP trigger frame 301 transmitted by the sharing AP 110.

In case the communication interface 113 of the sharing AP 110 has not received the completion notification frame 303 from the shared AP 120 within the time period 401 indicated in the M-AP trigger frame 301, the communication interface 113 may be configured to transmit the further M-AP trigger frame 301 to the further shared AP 120′ within the M-AP set, wherein the further M-AP trigger frame 301 is configured to solicit the further shared AP 120′ to initiate the Sequential Pre-TX coordination-related procedure with one or more non-AP stations associated with the further shared AP 120′ and/or with the one or more OBSS non-AP stations associated with the one or more further shared APs 120 operating under the same coordination agreement within the M-AP set. The further M-AP trigger frame 301 may be further configured to solicit the shared AP 120′ to transmit a further completion notification frame 303 indicating the completion of the coordination-related procedure to the sharing AP 110.

Thus, as illustrated in FIG. 4, if the time period 401 allocated for the current stage has ended and no completion notification frame 303 was received by the sharing AP 110 but may have been transmitted by the shared AP 120, the current stage may be marked as incomplete, and the next stage may be performed.

In case the communication interface 113 of the sharing AP 110 has not received the completion notification frame 303 indicating the completion of the sequential operation from the shared AP 120 within the time period 401 indicated in the preceding M-AP trigger frame 301, the communication interface 113 may be configured to transmit the further M-AP trigger frame 301 to the shared AP 120 within the M-AP set, wherein the further M-AP trigger frame 301 is configured to solicit the shared AP 120 to initiate the Sequential Pre-TX coordination-related procedure with the one or more non-AP stations associated with the shared AP 120 and/or with the one or more OBSS non-AP stations associated with the one or more further shared APs 120′ within the M-AP set. The further M-AP trigger frame 301 may be further configured to solicit the shared AP 120 to transmit the further completion notification frame 303 indicating the completion of the coordination-related procedure to the sharing AP 110.

Thus, as further illustrated in FIG. 4 if the time period 401 allocated for the current stage has ended and no completion notification frame 303 was received by the sharing AP 110 but may have been transmitted by the shared AP 120, the current stage may be marked as incomplete and may be retriggered. Depending on the type of procedure, the procedure may be stopped.

In case the Sequential Pre-TX coordination-related procedure is not completed within the time period 401 indicated in the M-AP trigger frame 301, the completion notification frame 303 may comprise an indication indicative of a request for an additional time period for performing the Sequential Pre-TX coordination-related procedure by that shared AP. The indication indicative of the request for an additional time period for performing the Sequential Pre-TX coordination-related procedure by the shared AP 120 may comprise a value of the additional required time period. Thus, the shared AP 120 may send a further completion notification frame 303, if more time is required.

Thus, sequential pre-TX coordination procedures may be efficiently managed by the sharing AP 110 using the new frames 301, 303 and rules described above. Moreover, no deadlock of the sequential procedure can happen due to the time limitation rules described above. The proposed frames 301, 303 may be used to execute different M-AP sequential Pre-TX coordination-related procedures, for example Sequential Sounding, Sequential Primary Channel Switch for Co-OFDMA or Power Control Info collecting for Co-UL MU-MIMO.

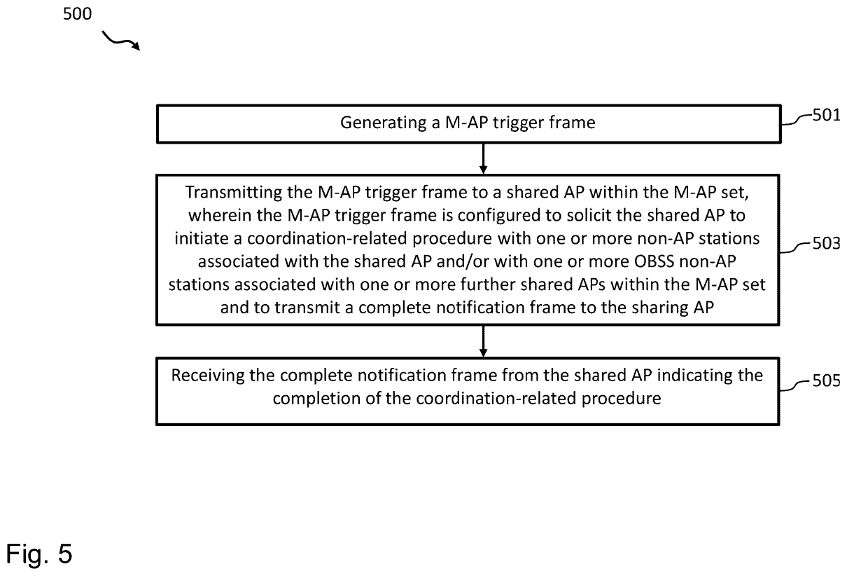

FIG. 5 is a flow diagram illustrating a method 500 of operating the sharing AP 110 according to an embodiment. As described above, the sharing access point 110 is configured to share at least a portion of the obtained transmission opportunity, TXOP, with one or more shared APs 120 within the Multi-AP, M-AP, set for participating in a coordinated transmission. The method 500 comprises a step 501 of generating a M-AP trigger frame 301 by the sharing AP. The method 500 further comprises a step 503 of transmitting the M-AP trigger frame 301 to a shared AP 120 operating under the coordination agreement within the M-AP set, wherein the M-AP trigger frame 301 is configured to solicit the shared AP 120 to initiate a Sequential Pre-TX coordination-related procedure with one or more non-AP stations associated with that shared AP 120 and/or with one or more OBSS non-AP stations associated with one or more further shared APs 120′ operating under the coordination agreement within the M-AP set and optionally indicating to transmit the completion notification frame 303 to the sharing AP 110. The method 500 further comprises a step 505 of receiving the completion notification frame 303 from the shared AP 120 indicating the completion of the Sequential Pre-TX coordination-related procedure performed by that shared AP 120.

As the method 500 can be implemented by the sharing AP 110, further features of the method 500 result directly from the functionality of the sharing AP 110 and its different embodiments described above and below.

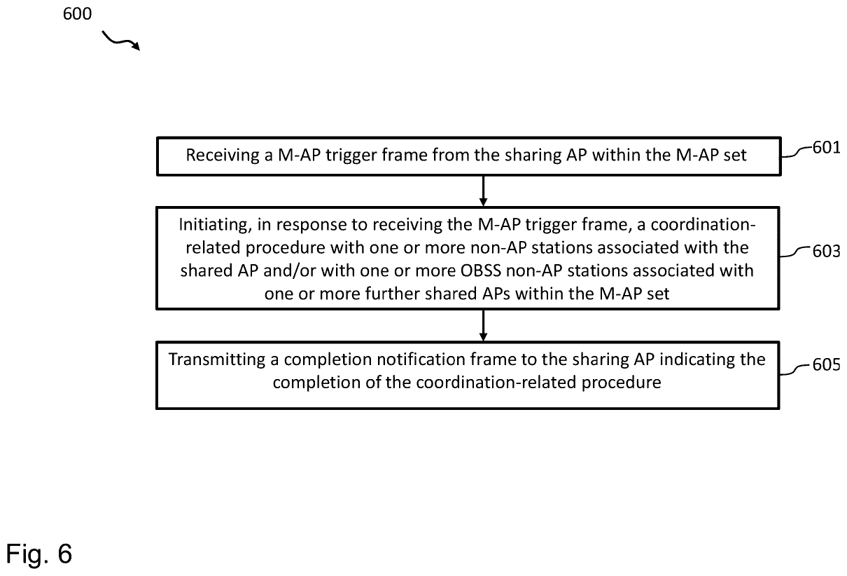

FIG. 6 is a flow diagram illustrating a method 600 of operating the shared AP 120 according to an embodiment. As described above, the shared access point, AP, 120 is configured to participate in a coordinated transmission making use of at least a portion of a transmission opportunity, TXOP, obtained and shared by the sharing AP 110 operating under the coordination agreement within the Multi-AP, M-AP, set. The method 600 comprises a step 601 of receiving a M-AP trigger frame 301 from the sharing AP 110 operating under the coordination agreement within the M-AP set. The method 600 comprises a further step 603 of initiating, in response to receiving the M-AP trigger frame 301, a Sequential Pre-TX coordination-related procedure with one or more non-AP stations associated with that shared AP 120 and/or with one or more OBSS non-AP stations associated with one or more further shared APs 120′ operating under the coordination agreement within the M-AP set. The method 600 comprises a further step 605 of transmitting the completion notification frame 303 to the sharing AP 110 indicating the completion of the Sequential Pre-TX coordination-related procedure.

As the method 600 can be implemented by the shared AP 120, further features of the method 600 result directly from the functionality of the shared AP 120 and its different embodiments described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments disclosed herein may be integrated into one processing unit, or each of the units may exist alone physically, or two or more units are integrated into one unit.

1. A sharing access point (AP) (110) configured to share at least a portion of a transmission opportunity (TXOP) with one or more shared APs (120) operating under the coordination agreement within a Multi-AP (M-AP) set for participating in a coordinated transmission, wherein the sharing AP (110) comprises:
at least one processor configured to generate a M-AP trigger frame (301); and
a communication interface (113) configured to transmit the M-AP trigger frame (301) to a shared AP (120) within the M-AP set, wherein the M-AP trigger frame (301) is configured to solicit the shared AP (120) to initiate a Sequential Pre-TX coordination-related procedure with at least one of one or more non-AP stations associated with the shared AP (120) or one or more OBSS non-AP stations associated with one or more further shared APs (120′) operating under the coordination agreement within the M-AP set and to transmit a completion notification frame (303) to the sharing AP (110);
wherein the communication interface (113) is further configured to receive from the shared AP (120) the completion notification frame (303) indicating the completion of the Sequential Pre-TX coordination-related procedure.

2. The sharing AP (110) of claim 1, wherein the M-AP trigger frame (301) comprises a M-AP set identifier indicative of the M-AP set.

3. The sharing AP (110) of claim 1, wherein the M-AP trigger frame (301) comprises a coordination agreement identifier within the M-AP set, wherein the coordination agreement identifier identifies one coordination agreement of a plurality of coordination agreements within the M-AP set and wherein the sharing AP (110) and the shared AP (120) operate under the coordination agreement identified by the coordination agreement identifier within the M-AP set.

4. The sharing AP (110) of claim 1, wherein the M-AP trigger frame (301) comprises an indication indicative of a type of the Sequential Pre-TX coordination-related procedure.

5. The sharing AP (110) of claim 4, wherein the M-AP trigger frame (301) comprises information about one or more parameters of the Sequential Pre-TX coordination-related procedure.

6. The sharing AP (110) of claim 1, wherein the M-AP trigger frame (301) comprises an indication to the shared AP (120) to initiate the transmission of the completion notification frame (303) indicating the completion of the Sequential Pre-TX coordination-related procedure towards the sharing AP (110).

7. The sharing AP (110) of claim 1, wherein the M-AP trigger frame (301) comprises an identifier of the shared AP.

8. The sharing AP (110) of claim 1, wherein the M-AP trigger frame (301) comprises an indication indicative of a time period for performing the Sequential Pre-TX coordination-related procedure with at least one of the one or more non-AP stations associated with the shared AP (120) or the one or more OBSS non-AP stations associated with the one or more further shared APs (120′) operating under the coordination agreement within the M-AP set.

9. The sharing AP (110) of claim 8, wherein, in case the communication interface (113) has not received the completion notification frame (303) indicating the completion of the sequential Pre-TX coordination-related procedure from the shared AP (120) within the time period indicated in the preceding M-AP trigger frame (301), the communication interface (113) is configured to transmit a further M-AP trigger frame (301) to the shared AP (120) within the M-AP set, wherein the further M-AP trigger frame (301) is configured to solicit the shared AP (120) to initiate the Sequential Pre-TX coordination-related procedure with at least one of the one or more non-AP stations associated with the shared AP (120) or the one or more OBSS non-AP stations associated with the one or more further shared APs (120′) operating under the coordination agreement within the M-AP set.

10. A shared access point (AP), (120) configured to participate in a coordinated transmission making use of at least a portion of a transmission opportunity (TXOP), obtained and shared by a sharing AP (110) operating under the coordination agreement within a Multi-AP (M-AP) set, wherein the shared AP (120) comprises:
a communication interface (123) configured to receive a M-AP trigger frame (301) from the sharing AP (110) operating under the coordination agreement within the M-AP set; and
at least one processor configured to, in response to receiving the M-AP trigger frame (301), initiating a Sequential Pre-TX coordination-related procedure with at least one of one or more non-AP stations associated with the shared AP (120) or one or more OBSS non-AP stations associated with one or more further shared APs (120′) operating under the coordination agreement within the M-AP set,
wherein the communication interface (123) is further configured to transmit a completion notification frame (303) to the sharing AP (110) indicating the completion of the Sequential Pre-TX coordination-related procedure.

11. The shared AP (120) of claim 10, wherein the M-AP trigger frame (301) comprises a coordination agreement identifier within the M-AP set, wherein the coordination agreement identifier identifies one coordination agreement of a plurality of coordination agreements within the M-AP set and wherein the sharing AP (110) and the shared AP (120) operate under the coordination agreement identified by the coordination agreement identifier within the M-AP set.

12. The shared AP (120) of claim 10, wherein the M-AP trigger frame (301) comprises a M-AP set identifier indicative of the M-AP set.

13. The shared AP (120) of claim 10, wherein the M-AP trigger frame (301) comprises an indication indicative of a type of the Sequential Pre-TX coordination-related procedure.

14. The shared AP (120) of claim 13, wherein the M-AP trigger frame (301) comprises information about one or more parameters of the Sequential Pre-TX coordination-related procedure.

15. The shared AP (120) of claim 10, wherein the M-AP trigger frame (301) comprises an indication to the shared AP (120) to initiate the transmission of the completion notification frame (303) indicating the completion of the Sequential Pre-TX coordination-related procedure towards the sharing AP (110).

16. The shared AP (120) of claim 10, wherein the M-AP trigger frame (301) comprises an identifier of the shared AP.

17. The shared AP (120) of claim 10, wherein the M-AP trigger frame (301) comprises an indication indicative of a time period for performing the Sequential Pre-TX coordination-related procedure with at least one of the one or more non-AP stations associated with the shared AP (120) or the one or more OBSS non-AP stations associated with the one or more further shared APs (120′) operating under the coordination agreement within the M-AP set.

18. The shared AP (120) of claim 17, wherein, in case the Sequential Pre-TX coordination-related procedure is not completed within the time period indicated in the M-AP trigger frame (301), the completion indication frame comprises an indication indicative of a request for an additional time period for performing the Sequential Pre-TX coordination-related procedure by the shared AP.

19. A method (500) of operating a sharing access point (AP) (110) configured to share at least a portion of a transmission opportunity (TXOP) with one or more shared APs (120) within a Multi-AP (M-AP) set for participating in a coordinated transmission, wherein the method (500) comprises:
generating (501) a M-AP trigger frame (301);
transmitting (503) the M-AP trigger frame (301) to a shared AP (120) operating under the coordination agreement within the M-AP set, wherein the M-AP trigger frame (301) is configured to solicit the shared AP (120) to initiate a Sequential Pre-TX coordination-related procedure with at least one of one or more non-AP stations associated with the shared AP (120) or one or more OBSS non-AP stations associated with one or more further shared APs (120′) operating under the coordination agreement within the M-AP set and to transmit a completion notification frame (303) towards the sharing AP (110); and
receiving (505) the completion notification frame (303) from the shared AP (120) indicating the completion of the Sequential Pre-TX coordination-related procedure.

20. The method of claim 19, wherein the M-AP trigger frame (301) comprises a M-AP set identifier indicative of the M-AP set.
